(19) United States
(12) Patent Application Publication
(10) Pub. No.: US 2026/0246397 A1
(43) Pub. Date: Aug. 20, 2026

(54) UNIFIED SUPPRESSION METHOD FOR EXTERNAL DISTURBANCES AND INTERNAL LEVITATION FORCE RIPPLES OF MAGNETIC LEVITATION MOTOR SYSTEM

(71) Applicant: Nanjing Guodian Nanzhi Power Grid Automation Co., Ltd, Nanjing (CN)

(72) Inventors: Ying LIU, Nanjing (CN); Yu ZOU, Nanjing (CN); Ye YUAN, Nanjing (CN); Fuguang WEN, Nanjing (CN); Huawei HE, Nanjing (CN); Peiyi LI, Nanjing (CN)

(73) Assignee: Nanjing Guodian Nanzhi Power Grid Automation Co., Ltd, Nanjing (CN)

(21) Appl. No.: 19/642,687

(22) Filed: Apr. 9, 2026

Related U.S. Application Data
(63) Continuation of application No. PCT/CN2024/114844, filed on Aug. 27, 2024.

(30) Foreign Application Priority Data
Jan. 2, 2024 (CN) 2024100086222

(51) Int. Cl. H02N 15/00; G05B 17/02

(52) U.S. Cl. CPC H02N 15/00; G05B 17/02

(57) ABSTRACT

A unified suppression method for external disturbances and internal levitation force ripples of a magnetic levitation motor system comprises: acquiring time-varying levitation force data of a magnetic levitation motor, and converting the time-varying levitation force data of the magnetic levitation motor into nominal levitation force feedback data of a time-invariant levitation force; designing a Kalman observer on the basis of the nominal levitation force feedback data; the Kalman observer observing and acquiring external disturbance and internal levitation force ripple data of a magnetic levitation motor system; and forwards feeding and supplementing the external disturbance and internal levitation force ripple data of the magnetic levitation motor system into a levitation control system of the magnetic levitation motor, thereby achieving unified suppression of external disturbances and internal levitation force ripples of the magnetic levitation motor system. The present disclosure can reduce the influence of external disturbances and internal levitation force ripples.

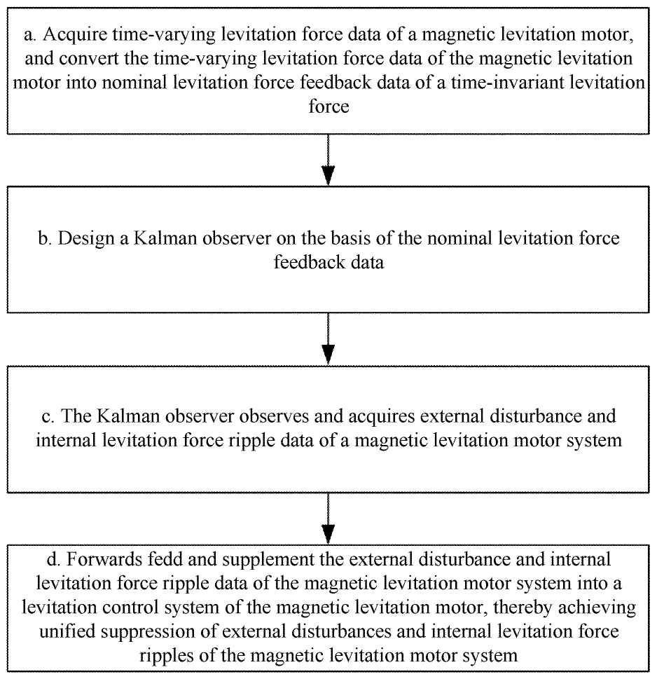

### CROSS-REFERENCE TO RELATED APPLICATIONS

The application claims priority to Chinese patent application No. 2024100086222, filed on Jan. 2, 2024, the entire contents of which are incorporated herein by reference.

### TECHNICAL FIELD

The present disclosure relates to the technical field of automatic control, and in particular to a unified suppression method for external disturbances and internal levitation force ripples of a magnetic levitation motor system.

### BACKGROUND

A magnetic levitation switched reluctance motor is obtained by integrating a switched reluctance motor and magnetic bearings. While retaining the advantages of the switched reluctance motor, such as a wide speed regulation range and high mechanical strength, the magnetic levitation switched reluctance motor can also provide a levitation force to achieve contactless operation of a rotor, thereby showing broad application prospects. However, the magnetic levitation switched reluctance motor is simultaneously affected by external disturbances and internal levitation force ripples. To address the above problems, conventional solutions generally equate a levitation force model to a steady-state levitation force model of the magnetic bearings. This type of levitation force model is related to a rotor displacement and a levitation force control current, but is independent of a rotor position. Although the above method can conveniently and quickly apply existing magnetic bearing control technology, it neglects the time-varying levitation force characteristics, making it difficult to further improve the levitation precision and the anti-disturbance performance.

### SUMMARY

An objective of the present disclosure is to solve at least one technical problem in the background, and to provide a unified suppression method for external disturbances and internal levitation force ripples of a magnetic levitation motor system.

To achieve the above objective, the present disclosure provides a unified suppression method for external disturbances and internal levitation force ripples of a magnetic levitation motor system, including:

acquiring time-varying levitation force data of a magnetic levitation motor, and converting the time-varying levitation force data of the magnetic levitation motor into nominal levitation force feedback data of a time-invariant levitation force;

designing a Kalman observer on the basis of the nominal levitation force feedback data;

the Kalman observer observing and acquiring external disturbance and internal levitation force ripple data of a magnetic levitation motor system; and

forwards feeding and supplementing the external disturbance and internal levitation force ripple data of the magnetic levitation motor system into a levitation control system of the magnetic levitation motor, thereby achieving unified suppression of external disturbances and internal levitation force ripples of the magnetic levitation motor system.

According to an aspect of the present disclosure, the nominal levitation force feedback data is obtained by averaging a current stiffness coefficient k_{iy}(θ) and a displacement stiffness coefficient k_{y}(θ) from the time-varying levitation force data within a mechanical angle of 0 to 2π;
the time-varying levitation force data of the magnetic levitation motor is as follows:

$${{{F}_{y} \approx \frac{\partial {F}_{y}}{\partial y} \vert}_{{y}_{1} = 0} {i}_{y} + \frac{\partial {F}_{y}}{\partial i} \vert}_{{i}_{y} = 0} {y}_{1} = {k}_{i y} ( θ ) {i}_{y} + {k}_{y} ( θ ) {y}_{1}$$

in the formula, i_{y} represents a levitation current, y₁ represents a displacement deviation, k_{iy}(θ) and k_{y}(θ) represent a radial current stiffness coefficient and a radial displacement stiffness coefficient:

$$\{ \begin{matrix}{k}_{y} ( θ ) = \frac{- {k}_{m} {B}_{r}^{2} {h}_{pm}^{2} {S}_{m} {S}_{1}^{2}}{2 {g}_{0} {{μ}_{0} ( 2 {h}_{pm} + {g}_{0} {S}_{1} )}^{2}} + \frac{- {B}_{r}^{2} {h}_{p m}^{2} {S}_{1}^{2} {S}_{f} ( θ )}{2 {g}_{1} {{μ}_{0} ( 2 {h}_{p m} {S}_{f} ( θ ) + {g}_{1} {S}_{1} )}^{2}} \\ {k}_{i y} ( θ ) = \frac{{k}_{m} {B}_{r} {h}_{p m} N {S}_{m} {S}_{1}}{{g}_{0} ( 2 {h}_{p m} {S}_{1 m} + {g}_{0} {S}_{1} )} + \frac{{B}_{r} {h}_{p m} N {S}_{1} {S}_{f} ( θ )}{{g}_{1}^{2} {S}_{1} + 2 {g}_{1} {h}_{pm} {S}_{f} ( θ )}\end{matrix}$$

averaging a current stiffness coefficient k_{iy}(θ) and a displacement stiffness coefficient k_{y}(θ) from the time-varying levitation force data within a mechanical angle of 0 to 2π yields the nominal levitation force feedback data:

$${F}_{y} = {\int }_{0}^{2 π} ( {k}_{i y} ( θ ) {i}_{y} + {k}_{y} ( θ ) {y}_{1} ) / ( 2 π ) = {k}_{i y}^{′} {i}_{y} + {k}_{y}^{′} {y}_{1}$$

in the formula,

$${k}_{i y}^{′} and {k}_{y}^{′}$$

represents a radial current stiffness coefficient and a radial displacement stiffness coefficient of the nominal levitation force feedback data, with a specific form as follows:

$$\{ \begin{matrix}{k}_{y}^{′} = \frac{- {k}_{m} {B}_{r}^{2} {h}_{pm}^{2} {S}_{m} {S}_{1}^{2}}{2 {g}_{0} {{μ}_{0} ( 2 {h}_{pm} + {g}_{0} {S}_{1} )}^{2}} + \frac{- 0.6 {B}_{r}^{2} {h}_{p m}^{2} {S}_{1}^{2} {S}_{m}}{2 {g}_{1} {{μ}_{0} ( 1.3 {h}_{p m} {S}_{m} + {g}_{1} {S}_{1} )}^{2}} \\ {k}_{i y} ( θ ) = \frac{{k}_{m} {B}_{r} {h}_{p m} N {S}_{m} {S}_{1}}{{g}_{0} ( 2 {h}_{p m} {S}_{1 m} + {g}_{0} {S}_{1} )} + \frac{0.65 {B}_{r} {h}_{p m} N {S}_{1} {S}_{m}}{{g}_{1}^{2} {S}_{1} + 1.3 {g}_{1} {h}_{pm} {S}_{m}}\end{matrix}$$

in the above formulas, kₘ represents a levitation force correction coefficient considering the influence of magnetic saturation, Bᵣ represents a remanence of a permanent magnet, hₚₘ represents a magnetization thickness of a permanent magnet ring, S₁ represents an area of the permanent magnet, Sₘ represents an area of a main magnetic flux, g₀ represents a length of a main magnetic flux path, g₁ represents a length of a fringing magnetic flux path, N represents the number of winding turns, and S_{f}(θ) represents an area of a fringing magnetic flux.

According to an aspect of the present disclosure, the designing a Kalman observer on the basis of the nominal levitation force feedback data includes:
establishing a single-degree-of-freedom state-space equation based on the nominal levitation force feedback data;
discretizing the state-space equation; and
designing a Kalman observer according to the discretized state-space equation.

According to an aspect of the present disclosure, the single-degree-of-freedom state-space equation established based on the nominal levitation force feedback data is as follows: \dot{x}=Ax+Bu+Cf;
in the formula,

$$A = ( \begin{matrix}0 & 1 \\ \frac{{k}_{y}^{′}}{m} & 0\end{matrix} ) , B = ( \begin{matrix}0 \\ \frac{{k}_{iy}^{′}}{m}\end{matrix} ) , C = ( \begin{matrix}0 \\ \frac{1}{m}\end{matrix} ) , and x = {( \begin{matrix}{x}_{r 1} & {x}_{r 2}\end{matrix} )}^{T} ,$$

where xᵣ₁ represents a displacement state variable, xᵣ₂ represents a derivative of displacement, x represents a state variable composed of xᵣ₁ and xᵣ₂, u represents an input current i, f represents a sum of external disturbances and internal levitation force ripples, and m represents a rotor mass;
the state-space equation is augmented by defining x=(xᵣ₁ xᵣ₂ xᵣ₃)^{T}, where xᵣ₃ is equal to f, and considering the influence of noise, the augmented state-space equation is as follows:

$$\{ \begin{matrix}\dot{x} = Ax + Bu + Cf + w \\ f = Hx + v\end{matrix} ;$$

in the formula, w represents process noise, and v represents measurement noise; and after augmentation,

$$A = ( \begin{matrix}0 & 1 & 1 \\ \frac{{k}_{y}^{′}}{m} & 0 & \frac{1}{m} \\ 0 & 0 & 0\end{matrix} ) , B = ( \begin{matrix}0 \\ \frac{{k}_{iy}^{′}}{m} \\ 0\end{matrix} ) , and H = ( \begin{matrix}0 & 0 & 1\end{matrix} ) .$$

According to an aspect of the present disclosure, the discretized state-space equation is as follows:

$$\{ \begin{matrix}{X}_{k} = {MX}_{k - 1} + {NU}_{k - 1} + {W}_{k - 1} \\ {Z}_{k} = {HX}_{k} + {V}_{k - 1}\end{matrix}$$

in the formula, M=I+TA, and N=TB, where T represents a discrete sampling time, Uₖ₋₁ represents a value of u at a moment k−1, Wₖ₋₁ represents a value of the process noise w at the moment k−1, Vₖ₋₁ represents a value of the measurement noise v at the moment k−1, Xₖ₋₁ represents a value of x at the moment k−1, Xₖ represents a value of x at a moment k, Zₖ represents a measurement value at the moment k, and I represents a 3rd-order identity matrix.

According to an aspect of the present disclosure, the Kalman observer is designed according to the discretized state-space equation, and the Kalman observer includes a prediction part;
prediction equations of the prediction part include:

$${\hat{X}}_{\frac{k}{k - 1}} = M {\hat{X}}_{k - 1} + N {U}_{k - 1}$$

$${P}_{\frac{k}{k - 1}} = M {P}_{k - 1} {M}^{T} + Q$$

in the formulas, X represents a discretized state variable of x, and

$${\hat{X}}_{\frac{k}{k - 1}} = M {\hat{X}}_{k - 1} + N {U}_{k - 1}$$

is a state one-step prediction equation, where

$${\hat{X}}_{\frac{k}{k - 1}}$$

represents a value of X predicted at the moment k from the moment k−1, \hat{X}ₖ₋₁ represents a predicted value of X at the moment k−1, and for an initial moment, the predicted value is a zero vector; and

$${P}_{\frac{k}{k - 1}} = M {P}_{k - 1} {M}^{T} + Q$$

is a one-step prediction covariance equation, where P represents a variance matrix of a filtering error, Pₖ₋₁ represents a value of P at the moment k−1, P_{k/k-1} represents a value of P at the moment k predicted at the moment k−1, and Q represents a covariance matrix of the process noise.

According to an aspect of the present disclosure, the Kalman observer is designed according to the discretized state-space equation, and the Kalman observer includes an update part;
update equations of the update part include:

$${K}_{k} = \frac{{P}_{\frac{k}{k - 1}} {H}^{T}}{H {P}_{\frac{k}{k - 1}} {H}^{T} + R}$$

$${\hat{X}}_{k} = {\hat{X}}_{\frac{k}{k - 1}} + {K}_{k} ( {Z}_{k} - H {\hat{X}}_{\frac{k}{k - 1}} )$$

$${P}_{k} = ( l - {K}_{k} H ) {P}_{\frac{k}{k - 1}}$$

in the formulas,

$${K}_{k} = \frac{{P}_{\frac{k}{k - 1}} {H}^{T}}{{HP}_{\frac{k}{k - 1}} {H}^{T} + R}$$

is a Kalman gain equation, where Kₖ represents a Kalman gain at the moment k, and R represents a covariance matrix of the measurement noise;

$${\hat{X}}_{k} = {\hat{X}}_{\frac{k}{k - 1}} + {K}_{k} ( {Z}_{k} - H {\hat{X}}_{\frac{k}{k - 1}} )$$

is a state estimation equation, where X̅ₖ represents a predicted value of X at the moment k; and

$${P}_{k} = ( I - {K}_{k} H ) {P}_{\frac{k}{k - 1}}$$

is an estimated mean square error equation, where I represents a 3rd-order identity matrix.

To achieve the above objective, the present disclosure further provides a unified suppression system for external disturbances and internal levitation force ripples of a magnetic levitation motor system, including:
a time-varying levitation force data acquisition and conversion module configured to acquire time-varying levitation force data of a magnetic levitation motor, and convert the time-varying levitation force data of the magnetic levitation motor into nominal levitation force feedback data of a time-invariant levitation force;
a Kalman observer design module configured to design a Kalman observer on the basis of the nominal levitation force feedback data;
an external disturbance and internal levitation force ripple data acquisition module configured to enable the Kalman observer to observe and acquire external disturbance and internal levitation force ripple data of a magnetic levitation motor system; and
a suppression module configured to forwards feed and supplement the external disturbance and internal levitation force ripple data of the magnetic levitation motor system into a levitation control system of the magnetic levitation motor, thereby achieving unified suppression of external disturbances and internal levitation force ripples of the magnetic levitation motor system.

To achieve the above objective, the present disclosure further provides an electronic device, including a processor, a memory, and a computer program stored on the memory and runnable on the processor, where the computer program, when executed by the processor, implements the above unified suppression method for external disturbances and internal levitation force ripples of a magnetic levitation motor system.

To achieve the above objective, the present disclosure further provides a computer-readable storage medium, where a computer program is stored on the computer-readable storage medium, and the computer program, when executed by a processor, implements the above unified suppression method for external disturbances and internal levitation force ripples of a magnetic levitation motor system.

According to the solution of the present disclosure, the Kalman observer is designed based on the nominal levitation force feedback data, the Kalman observer is configured to uniformly observe external disturbances and internal levitation force ripples, and the observed values are uniformly forwards fed and compensated into the levitation control system of the magnetic levitation motor. This solution can effectively reduce the impact of external disturbances and internal levitation force ripples on a magnetic levitation switched reluctance motor, thereby effectively improving the levitation precision and anti-disturbance performance of a magnetic levitation switched reluctance motor system.

### BRIEF DESCRIPTION OF DRAWINGS

The FIGURE is a flowchart of a unified suppression method for external disturbances and internal levitation force ripples of a magnetic levitation motor system according to an embodiment of the present disclosure.

### DETAILED DESCRIPTION OF THE EMBODIMENTS

The content of the present disclosure will now be discussed with reference to exemplary embodiments. It should be understood that the discussed embodiments are only for the purpose of enabling those of ordinary skill in the art to better understand and thereby implement the content of the present disclosure, and are not intended to imply any limitation on the scope of the present disclosure.

As used herein, the term “includes” and its variants are to be interpreted as open-ended terms meaning “includes, but is not limited to”. The term “based on” is to be interpreted as “based at least in part on”. The terms “one embodiment” and “an embodiment” are to be interpreted as “at least one embodiment”.

The FIGURE schematically shows a flowchart of a unified suppression method for external disturbances and internal levitation force ripples of a magnetic levitation motor system according to an embodiment of the present disclosure. As shown in the FIGURE, a unified suppression method for external disturbances and internal levitation force ripples of a magnetic levitation motor system includes:
a, time-varying levitation force data of a magnetic levitation motor is acquired, and converted into nominal levitation force feedback data of a time-invariant levitation force;
b, a Kalman observer is designed on the basis of the nominal levitation force feedback data;
c, the Kalman observer observes and acquires external disturbance and internal levitation force ripple data of a magnetic levitation motor system; and
d, the external disturbance and internal levitation force ripple data of the magnetic levitation motor system is forwards fed and supplemented into a levitation control system of the magnetic levitation motor, thereby achieving unified suppression of external disturbances and internal levitation force ripples of the magnetic levitation motor system

According to an embodiment of the present disclosure, in the above step a, the nominal levitation force feedback data is obtained by averaging a current stiffness coefficient k_{iy}(θ) and a displacement stiffness coefficient k_{y}(θ) from the time-varying levitation force data within a mechanical angle of 0 to 2π;
the time-varying levitation force data of the magnetic levitation motor is as follows:

$${F}_{y} \approx \frac{\partial {F}_{y}}{\partial y} {\vert}_{{y}_{1} = 0} {i}_{y} + \frac{\partial {F}_{y}}{\partial i} {\vert}_{{i}_{y} = 0} {y}_{1} = {k}_{i y} ( θ ) {i}_{y} + {k}_{y} ( θ ) {y}_{1}$$

in the formula, i_{y} represents a levitation current, y₁ represents a displacement deviation, k_{iy}(θ) and k_{y}(θ) represent a radial current stiffness coefficient and a radial displacement stiffness coefficient:

$$\{ \begin{matrix}{k}_{y} ( θ ) = \frac{- {k}_{m} {B}_{r}^{2} {h}_{pm}^{2} {S}_{m} {S}_{1}^{2}}{2 {g}_{0} {{μ}_{0} ( 2 {h}_{pm} {S}_{m} + {g}_{0} {S}_{1} )}^{2}} + \frac{- {B}_{r}^{2} {h}_{p m}^{2} {S}_{1}^{2} {S}_{f} ( θ )}{2 {g}_{1} {{μ}_{0} ( 2 {h}_{p m} {S}_{f} ( θ ) + {g}_{1} {S}_{1} )}^{2}} \\ {k}_{i y} ( θ ) = \frac{{k}_{m} {B}_{r} {h}_{p m} N {S}_{m} {S}_{1}}{{g}_{0} ( 2 {h}_{p m} {S}_{1 m} + {g}_{0} {S}_{1} )} + \frac{{B}_{r} {h}_{p m} N {S}_{1} {S}_{f} ( θ )}{{g}_{1}^{2} {S}_{1} + 2 {g}_{1} {h}_{pm} {S}_{f} ( θ )}\end{matrix}$$

averaging a current stiffness coefficient k_{iy}(θ) and a displacement stiffness coefficient k_{y}(θ) from the time-varying levitation force data within a mechanical angle of 0 to 2π yields the nominal levitation force feedback data:

$${F}_{y} = {\int }_{0}^{2 π} ( {k}_{i y} ( θ ) {i}_{y} + {k}_{y} ( θ ) {y}_{1} ) / ( 2 π ) = {k}_{iy}^{′} {i}_{y} + {k}_{y}^{′} {y}_{1}$$

in the formula,

$${k}_{iy}^{′} and {k}_{y}^{′}$$

represents a radial current stiffness coefficient and a radial displacement stiffness coefficient of the nominal levitation force feedback data, with a specific form as follows:

$$\{ \begin{matrix}{k}_{y}^{′} = \frac{- {k}_{m} {B}_{r}^{2} {h}_{pm}^{2} {S}_{m} {S}_{1}^{2}}{2 {g}_{0} {{μ}_{0} ( 2 {h}_{pm} {S}_{m} + {g}_{0} {S}_{1} )}^{2}} + \frac{- 0.65 {B}_{r}^{2} {h}_{pm}^{2} {S}_{1}^{2} {S}_{m}}{2 {g}_{1} {{μ}_{0} ( 1.3 {h}_{pm} {S}_{m} + {g}_{1} {S}_{1} )}^{2}} \\ {k}_{iy}^{′} = \frac{{k}_{m} {B}_{r} {h}_{pm} {NS}_{m} {S}_{1}}{{g}_{0} ( 2 {h}_{pm} {S}_{m} + {g}_{0} {S}_{1} )} + \frac{0.65 {B}_{r} {h}_{pm} {NS}_{1} {S}_{m}}{{g}_{1}^{2} {S}_{1} + 1.3 {g}_{1} {h}_{pm} {S}_{m}}\end{matrix}$$

in the above formulas, kₘ represents a levitation force correction coefficient considering the influence of magnetic saturation, Bᵣ represents a remanence of a permanent magnet, hₚₘ represents a magnetization thickness of a permanent magnet ring, S₁ represents an area of the permanent magnet, Sₘ represents an area of a main magnetic flux, g₀ represents a length of a main magnetic flux path, g₁ represents a length of a fringing magnetic flux path, N represents the number of winding turns, and S_{f}(θ) represents an area of a fringing magnetic flux.

Further, according to an embodiment of the present disclosure, in the above step b, the designing a Kalman observer on the basis of the nominal levitation force feedback data includes:
b1, a single-degree-of-freedom state-space equation is established based on the nominal levitation force feedback data;
b2, the state-space equation is discretized; and
b3, a Kalman observer is designed according to the discretized state-space equation.

Further, according to an embodiment of the present disclosure, in the above step b1, the single-degree-of-freedom state-space equation established based on the nominal levitation force feedback data is as follows: \dot{x}=Ax+Bu+Cf;
in the formula,

$$A = ( \begin{matrix}0 & 1 \\ \frac{{k}_{y}^{′}}{m} & 0\end{matrix} ) , B = ( \begin{matrix}0 \\ \frac{{k}_{i y}^{′}}{m}\end{matrix} ) , C = ( \begin{matrix}0 \\ \frac{1}{m}\end{matrix} ) , and x = {( {x}_{r 1} {x}_{r 2} )}^{T} ,$$

where xᵣ₁ represents a displacement state variable, xᵣ₂ represents a derivative of displacement, x represents a state variable composed of xᵣ₁ and xᵣ₂, u represents an input current i, f represents a sum of external disturbances and internal levitation force ripples, and m represents a rotor mass;
the state-space equation is augmented by defining x=(xᵣ₁ xᵣ₂ xᵣ₃)^{T}, where xᵣ₃ is equal to f, and considering the influence of noise, the augmented state-space equation is as follows:

$$\{ \begin{matrix}\dot{x} = Ax + Bu + Cf + w \\ f = Hx + v\end{matrix} ;$$

in the formula, w represents process noise, and v represents measurement noise, after augmentation,

$$A = ( \begin{matrix}0 & 1 & 0 \\ \frac{{k}_{y}^{′}}{m} & 0 & \frac{1}{m} \\ 0 & 0 & 0\end{matrix} ) , B = ( \begin{matrix}0 \\ \frac{{k}_{iy}^{′}}{m} \\ 0\end{matrix} ) , and H = ( \begin{matrix}0 & 0 & 1\end{matrix} ) .$$

Further, according to an embodiment of the present disclosure, in the above step b2, the discretized state-space equation is as follows:

$$\{ \begin{matrix}{X}_{k} = M {X}_{k - 1} + N {U}_{k - 1} + {W}_{k - 1} \\ {Z}_{k} = H {X}_{k} + {V}_{k - 1}\end{matrix}$$

in the formula, M=I+TA, and N=TB, where T represents a discrete sampling time, Uₖ₋₁ represents a value of u at a moment k−1, Wₖ₋₁ represents a value of the process noise w at the moment k−1, Vₖ₋₁ represents a value of the measurement noise v at the moment k−1, Xₖ₋₁ represents a value of x at the moment k−1, Xₖ represents a value of x at a moment k, Zₖ represents a measurement value at the moment k, and I represents a 3rd-order identity matrix.

Further, according to an embodiment of the present disclosure, in the above step b3, the Kalman observer is designed according to the discretized state-space equation, and the Kalman observer includes a prediction part;
prediction equations of the prediction part include:

$${\hat{X}}_{\frac{k}{k - 1}} = M {\hat{X}}_{k - 1} + N {U}_{k - 1}$$

$${P}_{\frac{k}{k - 1}} = {MP}_{k - 1} {M}^{T} + Q$$

in the formulas, X represents a discretized state variable of x, and

$${\hat{X}}_{\frac{k}{k - 1}} = M {\hat{X}}_{k - 1} + N {U}_{k - 1}$$

is a state one-step prediction equation, where

$${\hat{X}}_{\frac{k}{k - 1}}$$

represents a value of A predicted at the moment k from the moment k−1, \hat{X}ₖ₋₁ represents a predicted value of X at the moment k−1, and for an initial moment, the predicted value is a zero vector; and

$${P}_{\frac{k}{k - 1}} = M {P}_{k - 1} {M}^{T} + Q$$

is a one-step prediction covariance equation, where P represents a variance matrix of a filtering error, Pₖ₋₁ represents a value of P at the moment k−1, P_{k/k-1} represents a value of P at the moment k predicted at the moment k−1, and Q represents a covariance matrix of the process noise.

Further, according to an embodiment of the present disclosure, in the above step b3, the Kalman observer is designed according to the discretized state-space equation, and the Kalman observer includes an update part;
update equations of the update part include:

$${K}_{k} = \frac{{P}_{\frac{k}{k - 1}} {H}^{T}}{H {P}_{\frac{k}{k - 1}} {H}^{T} + R}$$

$${\hat{X}}_{k} = {\hat{X}}_{\frac{k}{k - 1}} + {K}_{k} ( {Z}_{k} - H {\hat{X}}_{\frac{k}{k - 1}} )$$

$${P}_{k} = ( I - {K}_{k} H ) {P}_{\frac{k}{k - 1}}$$

in the formulas,

$${K}_{k} = \frac{{P}_{\frac{k}{k - 1}} {H}^{T}}{H {P}_{\frac{k}{k - 1}} {H}^{T} + R}$$

is a Kalman gain equation, wherein Kₖ represents a Kalman gain at the moment k, and R represents a covariance matrix of the measurement noise;

$${\hat{X}}_{k} = {\hat{X}}_{\frac{k}{k - 1}} + {K}_{k} ( {Z}_{k} - H {\hat{X}}_{\frac{k}{k - 1}} )$$

is a state estimation equation, wherein \hat{X}ₖ represents a predicted value of X at the moment k; and

$${P}_{k} = ( I - {K}_{k} H ) {P}_{\frac{k}{k - 1}}$$

is an estimated mean square error equation, wherein I represents a 3rd-order identity matrix.

From the above prediction equations and update equations, it can be seen that a magnitude of the Kalman gain K depends on the values of Q and R. The larger Q is, the closer K is to 1, indicating that the output places more trust in the measured value. The larger R is, the closer K is to 0, indicating that the output places more trust in the estimated value. Therefore, it is only necessary to give an initial value X₀ of X and an initial value P₀ of P, and reasonably select Q and R. The Kalman observer can then uniformly observe external disturbances and internal levitation force ripples, thereby achieving unified suppression of the external disturbances and the internal levitation force ripples.

According to the above solution of the present disclosure, the Kalman observer is designed based on the nominal levitation force feedback data, the Kalman observer is configured to uniformly observe external disturbances and internal levitation force ripples, and the observed values are uniformly forwards fed and compensated into the levitation control system of the magnetic levitation motor. This solution can effectively reduce the impact of external disturbances and internal levitation force ripples on a magnetic levitation switched reluctance motor, thereby effectively improving the levitation precision and anti-disturbance performance of a magnetic levitation switched reluctance motor system.

Further, to achieve the above objective, the present disclosure further provides a unified suppression system for external disturbances and internal levitation force ripples of a magnetic levitation motor system, including:
a time-varying levitation force data acquisition and conversion module configured to acquire time-varying levitation force data of a magnetic levitation motor, and convert the time-varying levitation force data of the magnetic levitation motor into nominal levitation force feedback data of a time-invariant levitation force;
a Kalman observer design module configured to design a Kalman observer on the basis of the nominal levitation force feedback data;
an external disturbance and internal levitation force ripple data acquisition module configured to enable the Kalman observer to observe and acquire external disturbance and internal levitation force ripple data of a magnetic levitation motor system; and
a suppression module configured to forwards feed and supplement the external disturbance and internal levitation force ripple data of the magnetic levitation motor system into a levitation control system of the magnetic levitation motor, thereby achieving unified suppression of external disturbances and internal levitation force ripples of the magnetic levitation motor system.

According to an embodiment of the present disclosure, in the above time-varying levitation force data acquisition and conversion module, the nominal levitation force feedback data is obtained by averaging a current stiffness coefficient k_{iy}(θ) and a displacement stiffness coefficient k_{y}(θ) from the time-varying levitation force data within a mechanical angle of 0 to 2π;
the time-varying levitation force data of the magnetic levitation motor is as follows:

$${{{F}_{y} \approx \frac{\partial {F}_{y}}{\partial y} \vert}_{{y}_{1} = 0} {i}_{y} + \frac{\partial {F}_{y}}{\partial i} \vert}_{{i}_{y} = 0} {y}_{1} = {k}_{iy} ( θ ) {i}_{y} + {k}_{y} ( θ ) {y}_{1}$$

in the formula, i_{y} represents a levitation current, y₁ represents a displacement deviation, k_{iy}(θ) and k_{y}(θ) represent a radial current stiffness coefficient and a radial displacement stiffness coefficient:

$$\{ \begin{matrix}{k}_{y} ( θ ) = \frac{- {k}_{m} {B}_{r}^{2} {h}_{pm}^{2} {S}_{m} {S}_{1}^{2}}{2 {g}_{0} {{μ}_{0} ( 2 {h}_{pm} {S}_{m} + {g}_{0} {S}_{1} )}^{2}} + \frac{- {B}_{r}^{2} {h}_{p m}^{2} {S}_{1}^{2} {S}_{f} ( θ )}{2 {g}_{1} {{μ}_{0} ( 2 {h}_{p m} {S}_{f} ( θ ) + {g}_{1} {S}_{1} )}^{2}} \\ {k}_{i y} ( θ ) = \frac{{k}_{m} {B}_{r} {h}_{p m} {NS}_{m} {S}_{1}}{{g}_{0} ( 2 {h}_{p m} {S}_{1 m} + {g}_{0} {S}_{1} )} + \frac{{B}_{r} {h}_{p m} {NS}_{1} {S}_{f} ( θ )}{{g}_{0}^{2} {S}_{1} + 2 {g}_{1} {h}_{pm} {S}_{f} ( θ )}\end{matrix}$$

averaging a current stiffness coefficient k_{iy}(θ) and a displacement stiffness coefficient k_{y}(θ) from the time-varying levitation force data within a mechanical angle of 0 to 2π yields the nominal levitation force feedback data:

$${F}_{y} = {\int }_{0}^{2 π} ( {k}_{i y} ( θ ) {i}_{y} + {k}_{y} ( θ ) {y}_{1} ) / ( 2 π ) = {k}_{i y}^{′} {i}_{y} + {k}_{y}^{′} {y}_{1}$$

in the formula,

$${k}_{i y}^{′} and {k}_{y}^{′}$$

represent a radial current stiffness coefficient and a radial displacement stiffness coefficient of the nominal levitation force feedback data, with a specific form as follows:

$$\{ \begin{matrix}{k}_{y}^{′} ( θ ) = \frac{- {k}_{m} {B}_{r}^{2} {h}_{p m}^{2} {S}_{m} {S}_{1}^{2}}{2 {g}_{0} {{μ}_{0} ( 2 {h}_{p m} {S}_{m} + {g}_{0} {S}_{1} )}^{2}} + \frac{- 0.65 {B}_{r}^{2} {h}_{p m}^{2} {S}_{1}^{2} {S}_{m}}{2 {g}_{1} {{μ}_{0} ( 1.3 {h}_{p m} {S}_{m} + {g}_{1} {S}_{1} )}^{2}} \\ {k}_{i y}^{′} ( θ ) = \frac{{k}_{m} {B}_{r} {h}_{p m} N {S}_{m} {S}_{1}}{{g}_{0} ( 2 {h}_{p m} {S}_{m} + {g}_{0} {S}_{1} )} + \frac{0.65 {B}_{r} {h}_{p m} N {S}_{1} {S}_{m}}{{g}_{1}^{2} {S}_{1} + 1.3 {g}_{1} {h}_{p m} {S}_{m}}\end{matrix}$$

in the above formulas, kₘ represents a levitation force correction coefficient considering the influence of magnetic saturation, Bᵣ represents a remanence of a permanent magnet, hₚₘ represents a magnetization thickness of a permanent magnet ring, S₁ represents an area of the permanent magnet, Sₘ represents an area of a main magnetic flux, g₀ represents a length of a main magnetic flux path, g₁ represents a length of a fringing magnetic flux path, N represents the number of winding turns, and S_{f}(θ) represents an area of a fringing magnetic flux.

Further, according to an embodiment of the present disclosure, in the above Kalman observer design module, the designing a Kalman observer on the basis of the nominal levitation force feedback data includes:
a single-degree-of-freedom state-space equation is established based on the nominal levitation force feedback data;
the state-space equation is discretized; and
a Kalman observer is designed according to the discretized state-space equation.

Further, according to an embodiment of the present disclosure, the single-degree-of-freedom state-space equation established based on the nominal levitation force feedback data is as follows: \dot{x}=Ax+Bu+Cf;
in the formula,

$$A = ( \begin{matrix}0 & 1 \\ \frac{{k}_{y}^{′}}{m} & 0\end{matrix} ) , B = ( \begin{matrix}0 \\ \frac{{k}_{iy}^{′}}{m}\end{matrix} ) , C = ( \begin{matrix}0 \\ \frac{1}{m}\end{matrix} ) , and x = {( \begin{matrix}{x}_{r 1} & {x}_{r 2}\end{matrix} )}^{T} ,$$

where xᵣ₁ represents a displacement state variable, xᵣ₂ represents a derivative of displacement, x represents a state variable composed of xᵣ₁ and xᵣ₂, u represents an input current i, f represents a sum of external disturbances and internal levitation force ripples, and m represents a rotor mass;
the state-space equation is augmented by defining x=(xᵣ₁ xᵣ₂ xᵣ₃)^{T}, where xᵣ₃ is equal to f, and considering the influence of noise, the augmented state-space equation is as follows:

$$\{ \begin{matrix}\dot{x} = Ax + Bu + Cf + w \\ f = Hx + v\end{matrix} ;$$

in the formula, w represents process noise, and v represents measurement noise, after augmentation,

$$A = ( \begin{matrix}0 & 1 & 0 \\ \frac{{k}_{y}^{′}}{m} & 0 & \frac{1}{m} \\ 0 & 0 & 0\end{matrix} ) , B = ( \begin{matrix}0 \\ \frac{{k}_{iy}^{′}}{m}\end{matrix} ) , and H = ( \begin{matrix}0 & 0 & 1\end{matrix} ) .$$

Further, according to an embodiment of the present disclosure, the discretized state-space equation is as follows:

$$\{ \begin{matrix}{X}_{k} = M {X}_{k - 1} + N {U}_{k - 1} + {W}_{k - 1} \\ {Z}_{k} = H {X}_{k} + {V}_{k - 1}\end{matrix}$$

in the formula, M=I+TA, and N=TB, where T represents a discrete sampling time, Uₖ₋₁ represents a value of u at a moment k−1, Wₖ₋₁ represents a value of the process noise w at the moment k−1, Vₖ₋₁ represents a value of the measurement noise v at the moment k−1, Xₖ₋₁ represents a value of x at the moment k−1, Xₖ represents a value of x at a moment k, Zₖ represents a measurement value at the moment k, and I represents a 3rd-order identity matrix.

Further, according to an embodiment of the present disclosure, the Kalman observer is designed according to the discretized state-space equation, and the Kalman observer includes a prediction part;
prediction equations of the prediction part include:

$${\hat{X}}_{\frac{k}{k - 1}} = M {\hat{X}}_{k - 1} + N {U}_{k - 1}$$

$${P}_{\frac{k}{k - 1}} = M {P}_{k - 1} {M}^{T} + Q$$

in the formulas, X represents a discretized state variable of x, and

$${\hat{X}}_{\frac{k}{k - 1}} = M {\hat{X}}_{k - 1} + N {U}_{k - 1}$$

is a state one-step prediction equation, where

$${\hat{X}}_{\frac{k}{k - 1}}$$

represents a value or x predicted at the moment k from the moment k−1, \hat{X}ₖ₋₁ represents a predicted value of X at the moment k−1, and for an initial moment, the predicted value is a zero vector; and

$${P}_{\frac{k}{k - 1}} = M {P}_{k - 1} {M}^{T} + Q$$

is a one-step prediction covariance equation, where P represents a variance matrix of a filtering error, Pₖ₋₁ represents a value of P at the moment k−1, P_{k/k-1} represents a value of P at the moment k predicted at the moment k−1, and Q represents a covariance matrix of the process noise.

Further, according to an embodiment of the present disclosure, the Kalman observer is designed according to the discretized state-space equation, and the Kalman observer includes an update part;
update equations of the update part include:

$${K}_{k} = \frac{{P}_{\frac{k}{k - 1}} {H}^{T}}{{HP}_{\frac{k}{k - 1}} {H}^{T} + R}$$

$${\hat{X}}_{k} = {\hat{X}}_{\frac{k}{k - 1}} + {K}_{k} ( {Z}_{k} - H {\hat{X}}_{\frac{k}{k - 1}} )$$

$${P}_{k} = ( I - {K}_{k} H ) {P}_{\frac{k}{k - 1}}$$

in the formulas,

$${K}_{k} = \frac{{P}_{\frac{k}{k - 1}} {H}^{T}}{{HP}_{\frac{k}{k - 1}} {H}^{T} + R}$$

is a Kalman gain equation, wherein Kₖ represents a Kalman gain at the moment k, and R represents a covariance matrix of the measurement noise;

$${\hat{X}}_{k} = {\hat{X}}_{\frac{k}{k - 1}} + {K}_{k} ( {Z}_{k} - H {\hat{X}}_{\frac{k}{k - 1}} )$$

is a state estimation equation, wherein \hat{X}ₖ represents a predicted value of X at the moment k; and

$${P}_{k} = ( I - {K}_{k} H ) {P}_{\frac{k}{k - 1}}$$

is an estimated mean square error equation, wherein I represents a 3rd-order identity matrix.

From the above prediction equations and update equations, it can be seen that a magnitude of the Kalman gain K depends on the values of Q and R. The larger Q is, the closer K is to 1, indicating that the output places more trust in the measured value. The larger R is, the closer K is to 0, indicating that the output places more trust in the estimated value. Therefore, it is only necessary to give initial values X₀ and P₀, and reasonably select Q and R. The Kalman observer can then uniformly observe external disturbances and internal levitation force ripples, thereby achieving unified suppression of the external disturbances and the internal levitation force ripples.

According to the solution of the present disclosure, the Kalman observer is designed based on the nominal levitation force feedback data, the Kalman observer is configured to uniformly observe external disturbances and internal levitation force ripples, and the observed values are uniformly forwards fed and compensated into the levitation control system of the magnetic levitation motor. This solution can effectively reduce the impact of external disturbances and internal levitation force ripples on a magnetic levitation switched reluctance motor, thereby effectively improving the levitation precision and anti-disturbance performance of a magnetic levitation switched reluctance motor system.

Further, to achieve the above objective, the present disclosure further provides an electronic device, including a processor, a memory, and a computer program stored on the memory and runnable on the processor, where the computer program, when executed by the processor, implements the above unified suppression method for external disturbances and internal levitation force ripples of a magnetic levitation motor system.

Further, to achieve the above objective, the present disclosure further provides a computer-readable storage medium, where a computer program is stored on the computer-readable storage medium, and the computer program, when executed by a processor, implements the above unified suppression method for external disturbances and internal levitation force ripples of a magnetic levitation motor system.

Those of ordinary skill in the art may recognize that modules and algorithmic steps described in the embodiments disclosed herein may be implemented through electronic hardware, computer software, or a combination thereof. Whether these functions are executed in hardware or software depends on the particular applications and design constraints of the technical solutions. Those skilled in the art may employ different methods for each specific application to achieve the described functions, but such implementation should not be construed as exceeding the scope of the present disclosure.

Those skilled in the art may clearly understand that for the convenience and conciseness of description, the specific operating processes of the described devices and equipment may be referenced to the corresponding processes in the embodiments of the above method, which will not be repeated herein.

In the embodiments provided by the present disclosure, it should be understood that the disclosed device and method may also be implemented in other ways. For example, the device embodiments described above are merely illustrative. For example, the division of the modules is only a logical function division, and there may be other division methods in actual implementation. For example, a plurality of modules or components may be combined or integrated into another system, or some features may be omitted or not executed. In another aspect, the mutual coupling or direct coupling or communication connection shown or discussed may be through some interfaces, and the indirect coupling or communication connection of devices or modules may be in electrical, mechanical or other forms.

The modules described as separate components may or may not be physically separated. The components shown as modules may or may not be physical modules, i.e., they may be located in one place or distributed over a plurality of network modules. Some or all of the modules may be selected according to actual needs to achieve the objectives of the solutions of the embodiments of the present disclosure.

In addition, each functional module in the embodiments of the present disclosure may be integrated into one processing module, or each module may exist physically separately, or two or more modules may be integrated into one module.

If the function is implemented in the form of software function modules and sold or used as an independent product, the function may be stored in one computer-readable storage medium. Based on such understanding, the technical solution of the present disclosure may be embodied, either in essence or in the portion contributing to the prior art or in part of the technical solution, as a software product. This computer software product is stored in a storage medium, including some instructions for enabling a computer device (which may be a personal computer, server, network device, or the like) to execute all or part of the steps of the methods for sending/receiving energy-saving signals according to various embodiments of the present disclosure. The above storage medium includes various media that can store program codes, such as a USB flash drive, a mobile hard disk drive, a read-only memory (ROM), a random access memory (RAM), a magnetic disk, or an optical disk.

The above description is only preferred embodiments of the present application and an explanation of the applied technical principles. Those skilled in the art should understand that the inventive scope involved in the present disclosure is not limited to the technical solutions formed by the specific combination of the above technical features, but also covers other technical solutions formed by any combination of the above technical features or their equivalent features without departing from the inventive concept. For example, technical solutions formed by mutually replacing the above features with (but not limited to) technical features with similar functions disclosed in the present disclosure.

It should be understood that the sequence numbers of the steps in the summary and embodiments of the present disclosure do not imply an absolute order of execution. The execution order of each process should be determined by its function and internal logic, and should not constitute any limitation on the implementation process of the embodiments of the present disclosure.

What is claimed is:

1. A unified suppression method for external disturbances and internal levitation force ripples of a magnetic levitation motor system, comprising:
acquiring time-varying levitation force data of a magnetic levitation motor, and converting the time-varying levitation force data of the magnetic levitation motor into nominal levitation force feedback data of a time-invariant levitation force;
designing a Kalman observer on the basis of the nominal levitation force feedback data;
the Kalman observer observing and acquiring external disturbance and internal levitation force ripple data of a magnetic levitation motor system; and
forwards feeding and supplementing the external disturbance and internal levitation force ripple data of the magnetic levitation motor system into a levitation control system of the magnetic levitation motor, thereby achieving unified suppression of external disturbances and internal levitation force ripples of the magnetic levitation motor system.

2. The unified suppression method for external disturbances and internal levitation force ripples of a magnetic levitation motor system according to claim 1, wherein the nominal levitation force feedback data is obtained by averaging a current stiffness coefficient k_{iy}(θ) and a displacement stiffness coefficient k_{y}(θ) from the time-varying levitation force data within a mechanical angle of 0 to 2π;
the time-varying levitation force data of the magnetic levitation motor is as follows:
$${{{F}_{y} \approx \frac{\partial {F}_{y}}{\partial y} \vert}_{{y}_{1} = 0} {i}_{y} + \frac{\partial {F}_{y}}{\partial i} \vert}_{{i}_{y} = 0} {y}_{1} = {k}_{i y} ( θ ) {i}_{y} + {k}_{y} ( θ ) {y}_{1}$$
in the formula, i_{y} represents a levitation current, y₁ represents a displacement deviation, k_{iy}(θ) and k_{y}(θ) represent a radial current stiffness coefficient and a radial displacement stiffness coefficient:
$$\{ \begin{matrix}{k}_{y} ( θ ) = \frac{- {k}_{m} {B}_{r}^{2} {h}_{p m}^{2} {S}_{m} {S}_{1}^{2}}{2 {g}_{0} {{μ}_{0} ( 2 {h}_{p m} {S}_{m} + {g}_{0} {S}_{1} )}^{2}} + \frac{- {B}_{r}^{2} {h}_{p m}^{2} {S}_{1}^{2} {S}_{f} ( θ )}{2 {g}_{1} {{μ}_{0} ( 2 {h}_{p m} {S}_{f} ( θ ) + {g}_{1} {S}_{1} )}^{2}} \\ {k}_{i y} ( θ ) = \frac{{k}_{m} {B}_{r} {h}_{p m} N {S}_{m} {S}_{1}}{{g}_{0} ( 2 {h}_{p m} {S}_{1 m} + {g}_{0} {S}_{1} )} + \frac{{B}_{r} {h}_{p m} N {S}_{1} {S}_{f} ( θ )}{{g}_{1}^{2} {S}_{1} + 2 {g}_{1} {h}_{p m} {S}_{f} ( θ )}\end{matrix}$$
averaging a current stiffness coefficient k_{iy}(θ) and a displacement stiffness coefficient k_{y}(θ) from the time-varying levitation force data within a mechanical angle of 0 to 2π yields the nominal levitation force feedback data:
$${F}_{y} = {\int }_{0}^{2 π} ( {k}_{iy} ( θ ) {i}_{y} + {k}_{y} ( θ ) {y}_{1} ) / ( 2 π ) = {k}_{iy}^{′} {i}_{y} + {k}_{y}^{′} {y}_{1}$$
in the formula,
$${k}_{iy}^{′} and {k}_{y}^{′}$$
represent a radial current stiffness coefficient and a radial displacement stiffness coefficient of the nominal levitation force feedback data, with a specific form as follows:
$$\{ \begin{matrix}{k}_{y}^{′} = \frac{- {k}_{m} {B}_{r}^{2} {h}_{pm}^{2} {S}_{m} {S}_{1}^{2}}{2 {g}_{0} {{μ}_{0} ( 2 {h}_{pm} {S}_{m} + {g}_{0} {S}_{1} )}^{2}} + \frac{- 0.65 {B}_{r}^{2} {h}_{pm}^{2} {S}_{1}^{2} {S}_{m}}{2 {g}_{1} {{μ}_{0} ( 1.3 {h}_{pm} {S}_{m} + {g}_{1} {S}_{1} )}^{2}} \\ {k}_{iy}^{′} = \frac{{k}_{m} {B}_{r} {h}_{pm} {NS}_{m} {S}_{1}}{{g}_{0} ( 2 {h}_{pm} {S}_{m} + {g}_{0} {S}_{1} )} + \frac{- 0.65 {B}_{r} {h}_{pm} {NS}_{1} {S}_{m}}{{g}_{1}^{2} {S}_{1} + 1.3 {g}_{1} {h}_{pm} {S}_{m}}\end{matrix}$$
in the above formulas, kₘ represents a levitation force correction coefficient considering the influence of magnetic saturation, Bᵣ represents a remanence of a permanent magnet, hₚₘ represents a magnetization thickness of a permanent magnet ring, S₁ represents an area of the permanent magnet, Sₘ represents an area of a main magnetic flux, g₀ represents a length of a main magnetic flux path, g₁ represents a length of a fringing magnetic flux path, N represents the number of winding turns, and S_{f}(θ) represents an area of a fringing magnetic flux.

3. The unified suppression method for external disturbances and internal levitation force ripples of a magnetic levitation motor system according to claim 2, wherein the designing a Kalman observer on the basis of the nominal levitation force feedback data comprises:
establishing a single-degree-of-freedom state-space equation based on the nominal levitation force feedback data;
discretizing the state-space equation; and
designing a Kalman observer according to the discretized state-space equation.

4. The unified suppression method for external disturbances and internal levitation force ripples of a magnetic levitation motor system according to claim 3, wherein the single-degree-of-freedom state-space equation established based on the nominal levitation force feedback data is as follows: \dot{x}=Ax+Bu+Cf;
in the formula,
$$A = ( \begin{matrix}0 & 1 \\ \frac{{k}_{y}^{′}}{m} & 0\end{matrix} ) , B = ( \begin{matrix}0 \\ \frac{{k}_{iy}^{′}}{m}\end{matrix} ) , C = ( \begin{matrix}0 \\ \frac{1}{m}\end{matrix} ) , and x = {( \begin{matrix}{x}_{r 1} & {x}_{r 2}\end{matrix} )}^{T} ,$$
wherein xᵣ₁ represents a displacement state variable, xᵣ₂ represents a derivative of displacement, x represents a state variable composed of xᵣ₁ and xᵣ₂, u represents an input current i, f represents a sum of external disturbances and internal levitation force ripples, and m represents a rotor mass;
the state-space equation is augmented by defining x=(xᵣ₁ xᵣ₂ xᵣ₃)^{T}, wherein xᵣ₃ is equal to f, and considering the influence of noise, the augmented state-space equation is as follows:
$$\{ \begin{matrix}\dot{x} = Ax + Bu + Cf + w \\ f = Hx + v\end{matrix} ;$$
in the formula, w represents process noise, and v represents measurement noise; and after augmentation,
$$A = ( \begin{matrix}0 & 0 & 0 \\ \frac{{k}_{y}^{′}}{m} & 0 & \frac{1}{m} \\ 0 & 0 & 0\end{matrix} ) , B = ( \begin{matrix}0 \\ \frac{{k}_{iy}^{′}}{m} \\ 0\end{matrix} ) , and H = ( \begin{matrix}0 & 0 & 1\end{matrix} ) .$$

5. The unified suppression method for external disturbances and internal levitation force ripples of a magnetic levitation motor system according to claim 4, wherein the discretized state-space equation is as follows:
$$\{ \begin{matrix}{X}_{k} = {MX}_{k - 1} + {NU}_{k - 1} + {W}_{k - 1} \\ {Z}_{k} = {HX}_{k} + {V}_{k - 1}\end{matrix}$$
in the formula, M=I+TA, and N=TB, wherein T represents a discrete sampling time, Uₖ₋₁ represents a value of u at a moment k−1, Wₖ₋₁ represents a value of the process noise w at the moment k−1, Vₖ₋₁ represents a value of the measurement noise v at the moment k−1, Xₖ₋₁ represents a value of x at the moment k−1, Xₖ represents a value of x at a moment k, Zₖ represents a measurement value at the moment k, and I represents a 3rd-order identity matrix.

6. The unified suppression method for external disturbances and internal levitation force ripples of a magnetic levitation motor system according to claim 5, wherein the Kalman observer is designed according to the discretized state-space equation, and the Kalman observer comprises a prediction part;
prediction equations of the prediction part comprise:
$${\hat{X}}_{\frac{k}{k - 1}} = M {\hat{X}}_{k - 1} + {NU}_{k - 1}$$
$${P}_{\frac{k}{k - 1}} = {MP}_{k - 1} {M}^{T} + Q$$
in the formulas, X represents a discretized state variable of x, and
$${\hat{X}}_{\frac{k}{k - 1}} = M {\hat{X}}_{k - 1} + {NU}_{k - 1}$$
is a state one-step prediction equation, wherein
$${\hat{X}}_{\frac{k}{k - 1}}$$
represents a value of X predicted at the moment k from the moment k−1, \hat{X}ₖ₋₁ represents a predicted value of X at the moment k−1, and for an initial moment, the predicted value is a zero vector; and
$${P}_{\frac{k}{k - 1}} = {MP}_{k - 1} {M}^{T} + Q$$
is a one-step prediction covariance equation, wherein P represents a variance matrix of a filtering error, Pₖ₋₁ represents a value of P at the moment k−1, P_{k/k-1} represents a value of P at the moment k predicted at the moment k−1, and Q represents a covariance matrix of the process noise.

7. The unified suppression method for external disturbances and internal levitation force ripples of a magnetic levitation motor system according to claim 6, wherein the Kalman observer is designed according to the discretized state-space equation, and the Kalman observer comprises an update part;
update equations of the update part comprise:
$${K}_{k} = \frac{{P}_{\frac{k}{k - 1}} {H}^{T}}{{HP}_{\frac{k}{k - 1}} {H}^{T} + R}$$
$${\hat{X}}_{k} = {\hat{X}}_{\frac{k}{k - 1}} + {K}_{k} ( {Z}_{k} - H {\hat{X}}_{\frac{k}{k - 1}} )$$
$${P}_{k} = ( I - {K}_{k} H ) {P}_{\frac{k}{k - 1}}$$
in the formulas,
$${K}_{k} = \frac{{P}_{\frac{k}{k - 1}} {H}^{T}}{{HP}_{\frac{k}{k - 1}} {H}^{T} + R}$$
is a Kalman gain equation, wherein Kₖ represents a Kalman gain at the moment k, and R represents a covariance matrix of the measurement noise;
$${\hat{X}}_{k} = {\hat{X}}_{\frac{k}{k - 1}} + {K}_{k} ( {Z}_{k} - H {\hat{X}}_{\frac{k}{k - 1}} )$$
is a state estimation equation, wherein \hat{X}ₖ represents a predicted value of X at the moment k; and
$${P}_{k} = ( I - {K}_{k} H ) {P}_{\frac{k}{k - 1}}$$
an estimated mean square error equation, wherein I represents a 3rd-order identity matrix.

8. A unified suppression system for external disturbances and internal levitation force ripples of a magnetic levitation motor system, comprising:
a time-varying levitation force data acquisition and conversion module configured to acquire time-varying levitation force data of a magnetic levitation motor, and convert the time-varying levitation force data of the magnetic levitation motor into nominal levitation force feedback data of a time-invariant levitation force;
a Kalman observer design module configured to design a Kalman observer on the basis of the nominal levitation force feedback data;
an external disturbance and internal levitation force ripple data acquisition module configured to enable the Kalman observer to observe and acquire external disturbance and internal levitation force ripple data of a magnetic levitation motor system; and
a suppression module configured to forwards feed and supplement the external disturbance and internal levitation force ripple data of the magnetic levitation motor system into a levitation control system of the magnetic levitation motor, thereby achieving unified suppression of external disturbances and internal levitation force ripples of the magnetic levitation motor system.

9. An electronic device, comprising a processor, a memory, and a computer program stored on the memory and runnable on the processor, wherein the computer program, when executed by the processor, implements the unified suppression method for external disturbances and internal levitation force ripples of a magnetic levitation motor system according to claim 1.

10. A computer-readable storage medium, wherein a computer program is stored on the computer-readable storage medium, and the computer program, when executed by a processor, implements the unified suppression method for external disturbances and internal levitation force ripples of a magnetic levitation motor system according to claim 1.
